(19) United States
(12) Patent Application Publication
(10) Pub. No.: US 2001/0055341 A1
(43) Pub. Date: Dec. 27, 2001

(54) Communication system with MPEG-4 remote access terminal

(76) Inventors: Laurent Herrmann, Le Kremlin-Bicetre (FR); Raoul Mallart, Paris (FR)

Correspondence Address: U.S. Philips Corporation, 580 White Plains Road, Tarrytown, NY, 10591, US

(21) Appl. No.: 09/860,312

(22) Filed: May 18, 2001

(30) Foreign Application Priority Data
May 23, 2000 (EP) 00401430.4

(51) Int. Cl. H04N 7/12

(52) U.S. Cl. 375/240.25

(57) ABSTRACT

The invention relates to a communication system between a receiver 101 and a terminal 102, allowing the transmission and the processing of coded audiovisual data on said terminal of limited resources, via a communication link 105 of limited capacity. To this end, the communication system is characterized in that said receiver comprises selection means applied to said data stream, according to a bi-directional control signal exchanged with said terminal, for providing selected data sent towards said terminal. This invention is a cost-effective solution since processing steps are shared between the receiver and the terminal: the receiver is mainly responsible for the storage or forward management in dependence on what can be processed by the terminal, while said terminal mainly handles the rendering and display of said received selected data.

The present invention relates to a communication system comprising:

a receiver for receiving a data stream containing scene description information,

a terminal for communicating with said receiver via a communication link.

This invention may be used, for example, for a communication between a receiver and a terminal which exchanges data coded in accordance with the MPEG-4 standard (Moving Picture Experts Groups).

In client/server applications, the client, also called terminal, is not able to embed important CPU and memory means to process all data sent by the server, also called receiver, because of strong constraints which necessitate small size and weight. Moreover, if a large quantity of coded audiovisual data have to be streamed between the two sets over a local communication link, the bandwidth of said link must be at least as great as the amount of data streamed, which is not always the case with the bandwidths available in local networks as described in ITU communication standards and dedicated to consumer applications.

The international patent application WO 98/46006 describes a system and method allowing the adaptation of a non-adaptive system for playing/browsing coded audiovisual objects, such as the parametric system of MPEG-4. The corresponding terminal is referred to as the programmatic system and incorporates adaptivity on top of the parametric system. It comprises:

a demultiplexer (DEMUX) controlled by a digital media integration framework layer (DMIF), receiving data from a communication link,

buffers to store demultiplexed data,

scene graph and media decoders to decode scene and audiovisual objects,

a compositor and renderer ensuring the display of the scene.

This cited prior art document provides a method of interfacing coded audiovisual objects, allowing a non-adaptive terminal system to play and browse said audiovisual objects. It includes an interfacing method in the form of an application programming interface (API). In this method, the resources available to the terminal are taken into account by an application programming interface (API) situated in said terminal. Since this API itself occupies a large amount of the very central processing units (CPU), it reduces the amount of CPU available for processing said audiovisual objects, which leads to latency in the rendered scene and thus restricts real-time applications. Moreover, this method does not take into consideration the bandwidth available on the communication link providing said coded audiovisual objects to the terminal, resulting in saturation of said communication link and the loss of data, which in its turn leads to artefacts in the rendered scene.

It is an object of the invention to allow the transmission and the processing of coded audiovisual data on a terminal of limited resources via a communication link of limited capacity.

The present invention fills the gaps of the background art in a cost-effective manner. To this end, the communication system according to the invention is characterized in that said receiver comprises selection means applied to said data stream based on a bi-directional control signal exchanged with said terminal for providing selected data which are to be sent to said terminal.

Indeed, the terminal processes only data which are adapted to its capabilities, ensuring that no CPU limitations will occur. A signal is sent to the receiver to inform it of the terminal's capabilities. In response, the receiver sends to the terminal not only said selected data but also a signal informing the terminal of the characteristics of said selected data. With the knowledge of the bandwidth available on the communication link, data to be sent to said terminal are also selected by the receiver, so that an optimal occupancy of the bandwidth is obtained. This invention is a cost-effective solution because processing steps are shared between the receiver and the terminal: the receiver is mainly responsible for the storage or forward management according to what can be processed by the terminal, while said terminal mainly handles the rendering and display of said received selected data.

Detailed explanations and other aspects of the invention are given below.

The particular aspects of the invention will now be explained with reference to the embodiments described below and considered in connection with the accompanying drawings, in which identical parts or sub-steps are designated in the same manner:

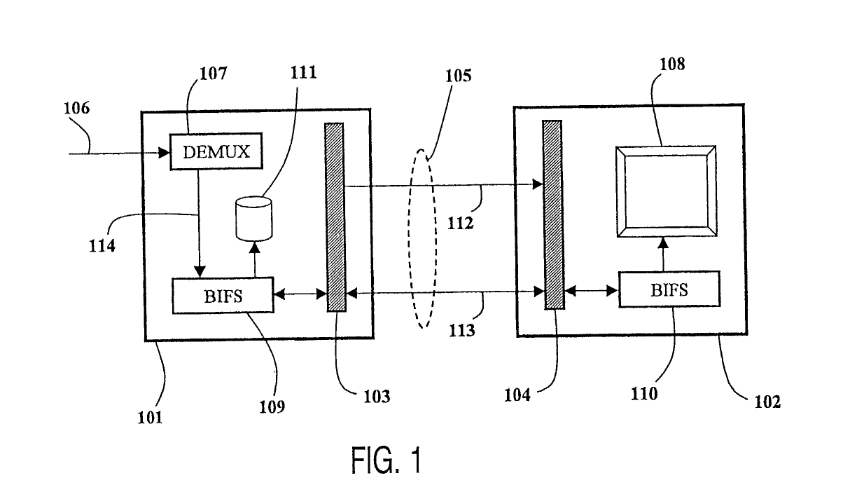

FIG. 1 depicts a block diagram of the communication system according to the invention between a receiver and a terminal,

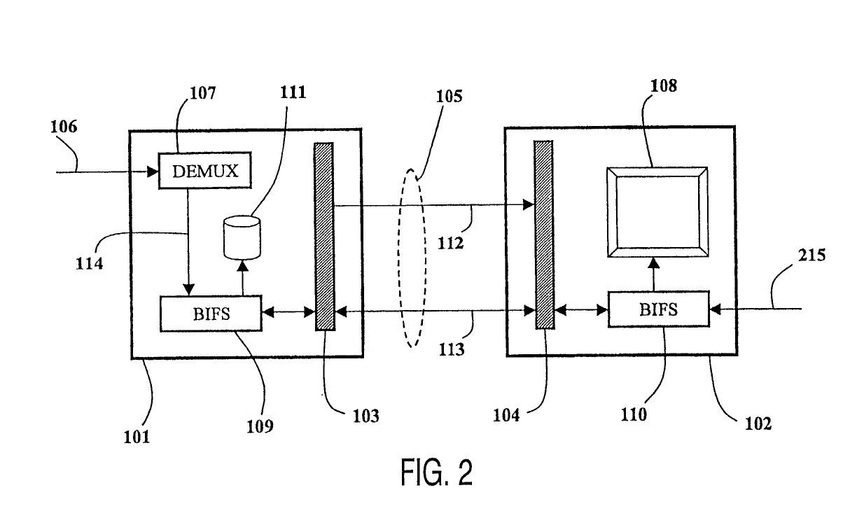

FIG. 2 depicts a block diagram of an improved communication system according to the invention between a receiver and a terminal,

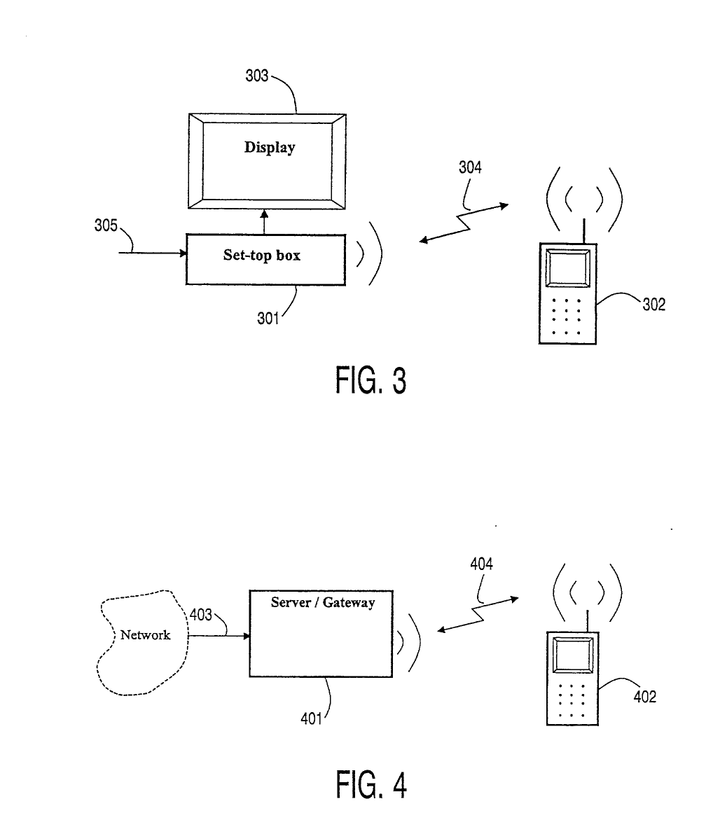

FIG. 3 illustrates a first embodiment of the technical solution according to the present invention,

FIG. 4 illustrates a second embodiment of the technical solution according to the present invention.

The present invention relates to an improved communication system between a receiver and a terminal of limited resources, via a communication link of limited capacity.

The invention is described for the case of MPEG-4 compressed data, but it will be apparent to a person skilled in the art that the scope of this invention is not limited to this specific case but may embrace to any type of object-oriented data-encoding language.

The MPEG-4 standard, referred to as ISO/IEC14496-1, provides functionality for multimedia data manipulation. It is well dedicated to scene compositions containing different natural or synthetic objects, such as two-or three-dimensional images (2D-3D), video clips, audio tracks, texts, or graphics. This standard allows scene content creation usable and compliant with multiple applications, allows a high flexibility in object combination, and offers means for user interaction in scenes containing multiple objects. This standard may find applications based on a client/server model consisting of a communication between a receiver and a terminal via a communication link. In such applications, data exchanged between the two sets are streamed over said communication link according to the protocol described by the MPEG-4 System. The MPEG-4 System comprises a compression layer including not only user interaction management, the decoding of the scene graph, and objects contained in the elementary stream sent by the server, but also the Binary Format for Scenes (BIFS) description. The scene description is encoded and transmitted to the terminal in parallel with encoded objects in elementary streams. The BIFS uses a compact representation of the scene components and is in charge of the MPEG-4 scene update mechanism and of the animation of some objects in the scenes.

FIG. 1 depicts a communication system according to the invention. It allows data exchange between a receiver and a terminal via a communication link. In particular, this communication system improves said data exchange if the communication link has a limited bandwidth or if the terminal has limited resources. According to the preferred embodiment illustrated in FIG. 1, the communication system receives an input signal 106 corresponding to a transport stream containing MPEG-4 data. The communication system according to the invention comprises:

a receiver device 101 which receives the input signal 106 and generates the output signal 112 containing selected MPEG-4 data and the output signal 113 containing bi-directional data control,

a communication link 105 allowing the transport of said signals 112 and 113,

a terminal device 102 receiving said signals 112 and 113 and allowing the composition and the rendering of said received selected MPEG-4 data, for example in audiovisual interactive applications.

The receiver comprises a demultiplexer 107 for demultiplexing said input data stream 106 and providing a demultiplexed signal 114 containing MPEG-4 data. Such data are sent to the MPEG-4 scene description unit referred to as the BIFS lower part and referenced by 109. The BIFS lower part analyses the scene graph relative to said MPEG-4 data while taking into account the terminal capabilities information contained in the control signal 113 sent by the respective terminal. The BIFS lower part is in charge of either storing/discarding said MPEG-4 data in the receiver, or forwarding said MPEG-4 data to the terminal. Indeed, if information relative to the terminal capabilities indicates that the processing means are not sufficient for treating incoming MPEG-4 data, e.g. because of a lack of CPU or memory space, said MPEG-4 data are discarded or stored in the local storage medium 111 for possible future use at the receiver side. On the contrary, if said information indicates that sufficient processing means are available in the terminal, said MPEG-4 data composing the signal 114 are forwarded to the communication interface 103. The BIFS lower part also selects MPEG-4 data subject to its knowledge of the bandwidth available on the communication link 105. If said bandwidth is sufficiently great to ensure the streaming of all MPEG-4 data to the terminal, MPEG-4 data are only selected in dependence on the capabilities of the terminal. If said bandwidth is limited, however, MPEG-4 data are not only selected in dependence on the capabilities of the terminal, but also by taking into account the maximum bandwidth available for ensuring that no saturation of the communication link occurs. The selection made by the BIFS lower part is based on the analysis of the MPEG-4 scene description contained in the demultiplexed data stream 114. The MPEG-4 scene description, by virtue of its hierarchical structure composed of nodes describing object characteristics and their links with other objects, allows the BIFS lower part to select the most representative or useful objects and to discard complex objects, so as to respect constraints both relative to the terminal capabilities and relative to the communication bandwidth. By this mechanism, MPEG-4 data sent to the terminal are not only compatible with the maximum bandwidth available on of the communication link 105, but also compatible with the processing means embedded in the terminal. For example, dealing with a terminal of limited resources, via a communication link of limited capacity, 3D-animated objects contained in BIFS elementary streams requiring not only a very great bandwidth occupancy but also considerable CPU processing means cannot be forwarded from the receiver to the terminal. In this case, said 3D-objects will be decoded in the receiver in order to be extracted from the incoming demultiplexed stream 114 and will not be sent to the terminal.

The communication interface 103, e.g. in communication with the Delivery Multimedia Interface Framework (DMIF), allows signals delivered by the BIFS lower part to be sent over the communication link 105 to the terminal. Such a communication interface also allows the interoperability between the receiver 101 and the terminal 102.

Once selected by the BIFS lower part, MPEG-4 data are sent to the communication interface 103 in order to be forwarded to the terminal. Since MPEG-4 data are linked to a scene description, the scene description relative to said MPEG-4 selected data is also sent to the terminal. The signal 112 is then composed of selected MPEG-4 data with their associated scene description contained in a single or in multiple elementary stream(s). Said scene description being the same as the one contained in the signal 114, however, the terminal, in order to take into account MPEG-4 objects discarded by the BIFS lower part and to be able to compose the scene corresponding to selected MPEG-4 data objects, is informed about modifications made by the BIFS lower part by means of the control signal 113 sent from the receiver. For example, the BIFS lower part may send information about the number of video objects selected and sent, the scalability level if dealing with a signal 114 containing scalable objects, the video rates, the scenes updates, or the output video formats.

The terminal 102 comprises a communication interface 104 which receives signals delivered by the communication link 105 and ensures the interoperability of said terminal with the receiver. This communication interface 104 receives the signal 112 containing selected MPEG-4 data with their associated scene description and also receives the control signal 113 containing useful information facilitating the scene composition of said selected MPEG-4 data. Said signals 112 and 113 are sent to the BIFS upper part 110 for composing the scene in accordance with the received MPEG-4 data. To this end, after decoding of objects contained in MPEG-4 data, the BIFS upper part fetches said objects according to the scene graph contained in the signal 112 while taking into account complementary information provided by the signal 113. Once composed, the corresponding multimedia scene is rendered and displayed by means of a display 108.

FIG. 2 depicts a communication system according to the invention similar to the one of FIG. 1 but offering to a user at the terminal side the possibility to interact within the rendered multimedia scene. The wish of the user, symbolized by the input signal 215 resulting, for example, from a mouse click or an action on a button, is analyzed by the BIFS upper part 110 via signal 215 to determine which objects contained in the scene are affected by the user action. The corresponding request, contained in control signal 113, is then sent to the receiver 101 via the communication interface 104. After receiving the request, the communication interface 103 sends said signal 113 to the BIFS lower part so that the user wish can be interpreted, so that only requested data are selected by said BIFS lower part from among MPEG-4 objects contained in signal 114 and are sent to the terminal via signal 112. In response, the receiver also sends information via signal 113 in order that the scene composition and rendering are made possible in the terminal. In this arrangement, the limited resources of the terminal 102 and the limited capacity of the communication link 105 are taken into consideration in that selected data corresponding to a user request are sent via signal 112 in accordance with signal 113 sent by the terminal.

FIG. 3 illustrates an example of a communication system according to the invention for multimedia data exchange between at least one receiver 301 and at least one terminal 302 via a communication link 304. In this example depicted in FIG. 3, the receiver 301 is a set-top box receiving an input data transport stream 305 and is capable of displaying decoded multimedia scenes contained in said transport stream by means of a display 303. The terminal 302 is a mobile device embedding a display displaying selected multimedia data sent by the receiver. Such a terminal may correspond to a notebook or a personal digital assistant (PDA). Said receiver and terminal constitute a BIFS lower part and a BIFS upper part, respectively, as described with reference to FIG. 1, the BIFS lower part mainly allowing the selection of data to be sent to the terminal while respecting both terminal resources and communication link bandwidth constraints, and the BIFS upper part mainly allowing the composition and rendering of said received selected data. In this example, the communication may, for example, correspond to a wireless channel using a GPRS network or the Bluetooth protocol.

FIG. 4 illustrates an example of a communication system according to the invention for multimedia data exchange between at least one receiver 401 and at least one terminal 402 via a communication link 404. In this example depicted in FIG. 4, the receiver 401 is a server or a gateway receiving an input data stream 406 from a local network or a wide network such as Internet. The terminal 402 is a device embedding a display displaying received multimedia data, such as a notebook/PDA or a personal computer. Said receiver and terminal constitute a BIFS lower part and a BIFS upper part, respectively, as described with reference to FIG. 1, the BIFS lower part mainly allowing the selection of data to be sent to the terminal while respecting both terminal resources and communication link bandwidth constraints, and the BIFS upper part mainly allowing the composition and rendering of said received selected data. This example may be used for data exchange dealing with a restricted-bandwidth network between the receiver and the terminal, as is it the case with a modem connection or ADSL data exchange.

Of course, this invention may also be used for data exchange between receivers and terminals different than those described above without departing from the scope and the pertinence of said invention.

This invention allowing the transmission and the processing of coded audiovisual data in a terminal of limited resources via a communication link of limited =capacity, can be implemented in several manners, such as by means of wired electronic circuits or, alternatively, by means of a set of instructions stored in a computer-readable medium, said instructions replacing at least part of said circuits and being executable under the control of a computer or a digital processor in order to carry out the same functions as fulfilled in said replaced circuits. The invention then also relates to a computer-readable medium comprising a software module which includes computer-executable instructions for performing the steps, or some steps, of the method, described above.

1. A communication system comprising a receiver for receiving a data stream containing scene description information and a terminal for communicating with said receiver via a communication link, characterized in that said receiver comprises selection means applied to said data stream based on a bi-directional control signal exchanged with said terminal, for providing selected data which are to be sent to said terminal.

2. A communication system as claimed in claim 1 characterized in that said bi-directional signal contains data for informing said receiver of the capabilities of the terminal and contains data for informing said terminal of the characteristics of said selected data.

3. A communication system as claimed in claim 1 characterized in that said terminal comprises compositor and rendering means for said selected data.

4. A method for data exchange between a receiver receiving a data stream containing scene description information and a terminal via a communication link, characterized in that it comprises a selection step applied to said data stream based on a bi-directional control signal exchanged with said terminal for providing selected data which are to be sent to said terminal.

5. A method as claimed in claim 4 characterized in that said bi-directional signal contains data for informing said receiver of the capabilities of the terminal and contains data for informing said terminal of the characteristics of said selected data.

6. A communication system as claimed in any one of claims 1 to 3, wherein the receiver is a set-top box, and the terminal is a portable digital assistant.

7. A communication system as claimed in any one of claims 1 to 3, wherein the receiver is a server, and the terminal is a portable digital assistant.

8. A communication system as claimed in anyone of claims 1 to 3, wherein the receiver is a server, and the terminal is a personal computer.

9. A computer program product for a transcoding device for adding data to an encoded data signal, which product comprises a set of instructions which, when loaded into said device, causes said device to carry out the method as claimed in claim 4 or 5.
